(19) United States
(12) Patent Application Publication
(10) Pub. No.: US 2012/0188669 A1
(43) Pub. Date: Jul. 26, 2012

(54) SEMICONDUCTOR INTEGRATED CIRCUIT

(76) Inventor: Jang-Hoo KIM, Gyeonggi-do (KR)

(21) Appl. No.: 13/333,756

(22) Filed: Dec. 21, 2011

(30) Foreign Application Priority Data
Jan. 26, 2011 (KR) 10-2011-0007725

(51) Int. Cl. H02H 9/04

(52) U.S. Cl. 361/56

(57) ABSTRACT

A semiconductor integrated circuit includes an interface pad unit, an input buffer unit configured to receive an external signal through the input buffer unit, an electrostatic discharge unit configured to discharge a static electricity from the interface pad unit, and an input buffer protection unit configured to electrically disconnect the interface pad unit and the input buffer unit from each other when the static electricity is generated.

### CROSS-REFERENCE TO RELATED APPLICATIONS

The present application claims priority of Korean Patent Application No. 10-2011-0007725, filed on Jan. 26, 2011, which is incorporated herein by reference in its entirety.

### BACKGROUND

1. Field

Exemplary embodiments of the present invention relate to a semiconductor integrated circuit, and more particularly, to a semiconductor integrated circuit for protecting internal circuits from electrostatic discharge.

2. Description of the Related Art

When a semiconductor integrated circuit comes in contact with a human body or machine, static electricity electrified/charged in the human body or machine is applied to the inside of a semiconductor integrated circuit. Since the applied static electricity has a voltage level, e.g., 1000V, much higher than the voltage level of a power supply voltage, e.g., 3V, which is generally used in a semiconductor integrated circuit, the static electricity may damage the internal circuits of the semiconductor integrated circuit. In particular, a gate oxide layer of a circuit formed of a metal oxide semiconductor (MOS) device among the internal circuits is easily damaged by high static electricity. For this reason, most semiconductor integrated circuits are equipped with a circuit structure for protection against the discharge of static electricity.

FIG. 1 is a schematic diagram illustrating a conventional semiconductor integrated circuit including an electrostatic discharge circuit.

Referring to FIG. 1, the conventional semiconductor integrated circuit includes an interface pad unit 101, an input buffer unit 103, a diode unit 105, an electrostatic sensing unit 107, a first discharge unit 109, and a second discharge unit 111.

The input buffer unit 103 receives an external signal through the interface pad unit 101. The interface pad unit 101 may include a data pad for the input or output of a data.

The diode unit 105 includes a first diode D1 for making a current flow from the interface pad unit 101 to a power supply voltage end VDD and a second diode D2 for making a current flow from a ground voltage end VSS to the interface pad unit 101.

The electrostatic sensing unit 107 includes a capacitor C1 and a resistor R1 that are serially coupled between the power supply voltage end VDD and the ground voltage end VSS. When static electricity is generated, a voltage of a predetermined level is clamped at a node NDET between the capacitor C1 and the resistor R1.

The first discharge unit 109 includes an NMOS transistor T1 that has a drain-source path between the power supply voltage end VDD and the ground voltage end VSS and receives the voltage of the node NDET of the electrostatic sensing unit 107 as a gate voltage. When static electricity is generated and the voltage of the node NDET is raised over a predetermined level, the NMOS transistor T1 is turned on to form a current path between the power supply voltage end VDD and the ground voltage end VSS.

The second discharge unit 111 includes a resistor R2 disposed in a signal transfer path between the interface pad unit 101 and the input buffer unit 103 and NMOS transistors NM1 and NM2 that are coupled in parallel to an input end of the input buffer unit 103 and respectively coupled with the power supply voltage end VDD and the ground voltage end VSS.

Here, the NMOS transistors NM1 and NM2 may include a Ground Gated NMOS (GGNMOS) transistor whose gate is coupled with the ground voltage end VSS.

Described hereafter is a discharge operation of the semiconductor integrated circuit shown in FIG. 1 when static electricity is generated.

Here, the generation of static electricity may mean that a positive electrostatic voltage or negative electrostatic voltage is applied to the interface pad unit 101 and the voltage between the interface pad unit 101 and the ground voltage end VSS or the voltage between the power supply voltage end VDD and the interface pad unit 101 momentarily surges.

When a positive electrostatic voltage is applied to the interface pad unit 101, an alternating current (AC) of electrostatic current momentarily flows from the interface pad unit 101 toward the power supply voltage end VDD into the capacitor C1 through the first diode D1, and a voltage drop occurs through the resistor R1 and thus the gate-source voltage of the NMOS transistor T1 becomes higher than a threshold voltage Vth thereof. Therefore, the NMOS transistor T1 is turned on to form a current path between the power supply voltage end VDD and the ground voltage end VSS and most of the static electricity may be discharged through the current path.

Some remaining static electricity may flow toward the input buffer unit 103, but the remaining static electricity is primarily blocked off by the resistor R2 and discharged to both voltage ends VDD and VSS through a parasitic Bipolar Junction Transistor (BJT) operation of the GGNMOS transistors NM1 and NM2 so as to protect the input buffer unit 103.

However, the thickness of a gate oxide layer of a MOS device in a semiconductor integrated circuit is becoming thinner and thinner due to growing trends towards the high performance and high integration of semiconductor devices. Accordingly, the breakdown voltage, at which the gate oxide layer is destroyed, is lowered as well, and thus the conventional semiconductor integrated circuit shown in FIG. 1 may not protect the internal circuit devices from electrostatic discharge.

### SUMMARY

Exemplary embodiments of the present invention are directed to a semiconductor integrated circuit which is capable of protecting internal circuits from electrostatic discharge in an effective manner.

In accordance with an exemplary embodiment of the present invention, a semiconductor integrated circuit includes an interface pad unit, an input buffer unit configured to receive an external signal through the input buffer unit, an electrostatic discharge unit configured to discharge a static electricity from the interface pad unit, and an input buffer protection unit configured to electrically disconnect the interface pad unit and the input buffer unit from each other when the static electricity is generated.

In accordance with another exemplary embodiment of the present invention, a semiconductor integrated circuit includes an interface pad unit, an input buffer unit configured to receive an external signal through the input buffer unit, an electrostatic discharge unit configured to sense a static electricity applied from the interface pad unit, discharge the static electricity, and activate a discharge signal, and an input buffer protection unit configured to electrically disconnect the interface pad unit and the input buffer unit from each other in response to the discharge signal.

### BRIEF DESCRIPTION OF THE DRAWINGS

FIG. 1 is a schematic diagram illustrating a conventional semiconductor integrated circuit including an electrostatic discharge circuit.

FIG. 2 is a schematic diagram illustrating a semiconductor integrated circuit in accordance with an exemplary embodiment of the present invention.

FIG. 3 illustrates an operation of an input buffer protection unit 203 when static electricity is generated in the semiconductor integrated circuit shown in FIG. 2.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

FIG. 2 is a schematic diagram illustrating a semiconductor integrated circuit in accordance with an embodiment of the present invention.

Referring to FIG. 2, the semiconductor integrated circuit includes an interface pad unit 101, an input buffer unit 103, an electrostatic discharge unit 201, and an input buffer protection unit 203.

The input buffer unit 103 receives an external signal through the interface pad unit 101. The electrostatic discharge unit 201 discharges static electricity when the static electricity is generated in the interface pad unit 101. The input buffer protection unit 203 electrically disconnects the interface pad unit 101 and the input buffer unit 103 from each other when the static electricity is generated.

The electrostatic discharge unit 201 may include a diode 105, an electrostatic sensor 107, a first discharger 109, and a second discharger 111. The diode 105 discharges charges from the interface pad unit 101 to a power supply voltage end VDD or a ground voltage end VSS when static electricity is generated. The electrostatic sensor 107 activates a discharge signal when the static electricity is generated. The electrostatic discharge unit senses the static electricity applied from the interface pad unit. The first discharger 109 forms a current path between the power supply voltage end VDD and the ground voltage end VSS when the discharge signal is activated. The second discharger 111 forms a current path between the interface pad unit 101 and the power supply voltage end VDD or between the interface pad unit 101 and the ground voltage end VSS when the discharge signal is activated.

Here, the generation of static electricity may mean that a positive electrostatic voltage or negative electrostatic voltage is applied to the interface pad unit 101 and the voltage between the interface pad unit 101 and the ground voltage end VSS or the voltage between the power supply voltage end VDD and the interface pad unit 101 momentarily surges.

The diode 105 may include a first diode D1 for discharging positive charges to the power supply voltage end VDD when a positive electrostatic voltage is applied to the interface pad unit 101 and a second diode D2 for discharging negative charges to the ground voltage end VSS when a negative electrostatic voltage is applied to the interface pad unit 101. In other words, when a positive electrostatic voltage is applied to the interface pad unit 101, an electrostatic current flows from the interface pad unit 101 toward the power supply voltage end VDD through the first diode D1. When a negative electrostatic voltage is applied to the interface pad unit 101, an electrostatic current flows from the ground voltage end VSS toward the interface pad unit 101 through the second diode D2.

The electrostatic sensor 107 may include a capacitor C1 coupled with the power supply voltage end VDD and a resistor R1 coupled with the ground voltage end VSS that are coupled in series. The electrostatic sensor 107 activates a discharge signal when static electricity is generated.

Here, the discharge signal is applied from a node NDET between the capacitor C1 and the resistor R1. The activation of the discharge signal means that the voltage of the node NDET is raised over a predetermined voltage level. Since no current flows through the resistor R1 during a normal operation sate of a semiconductor integrated circuit, the voltage of the node NDET is the same as the level of the ground voltage end VSS. However, when static electricity is generated in the interface pad unit 101, an alternating current (AC) of electrostatic current momentarily flows through the interface pad unit 101, and a voltage drop occurs though the resistor R1 and thus the voltage of the node NDET is raised over a predetermined voltage level. The increase of the voltage of the node NDET over a predetermined voltage level is referred to as the activation of the discharge signal.

The first discharger 109 includes an NMOS transistor T1 that has a drain-source path between the power supply voltage end VDD and the ground voltage end VSS and receives the voltage of the node NDET of the electrostatic sensor 107 as a gate voltage. When static electricity is generated and the discharge signal is activated, that is, when the voltage of the node NDET is raised over a predetermined level, the NMOS transistor T1 that receives the discharge signal through a gate is turned on to form a current path between the power supply voltage end VDD and the ground voltage end VSS. Most of the static electricity is discharged through the current path.

The second discharger 111 includes a resistor R2 disposed in a signal transfer path between the interface pad unit 101 and the input buffer unit 103 and NMOS transistors NM1 and NM2 that are coupled between the power supply voltage end VDD and the ground voltage end VSS. The NMOS transistors NM1 and NM2 discharge the remaining static electricity through a parasitic Bipolar Junction Transistor (BJT) operation when the static electricity is generated. Here, the NMOS transistors NM1. and NM2 may include Ground Gated NMOS (GGNMOS) transistors NM1 and NM2 whose gates are coupled with the ground voltage end VSS.

The input buffer protection unit 203 may include a MOS transistor that has a drain-source path between the interface pad unit 101 and the input buffer unit 103 and receives a discharge signal through a gate. When static electricity is generated and the discharge signal is activated, the MOS transistor is turned off to function as a capacitor between the interface pad unit 101 and the input buffer unit 103. In this embodiment of the present invention, the MOS transistor includes a PMOS transistor PM1 that receives the voltage of the node NDET of the electrostatic sensor 107 through a gate.

Since the PMOS transistor PM1 receives the voltage of the node NDET of the electrostatic sensor 107 through a gate, the PMOS transistor PM1 is applied with a ground voltage VSS and maintains a turn-on state during a normal operation of the semiconductor integrated circuit. However, when static electricity is generated, the voltage of the node NDET is raised and the PMOS transistor PM1 is turned off. Therefore, some electrostatic current flowing to the input buffer unit 103 through the resistor R2 is blocked.

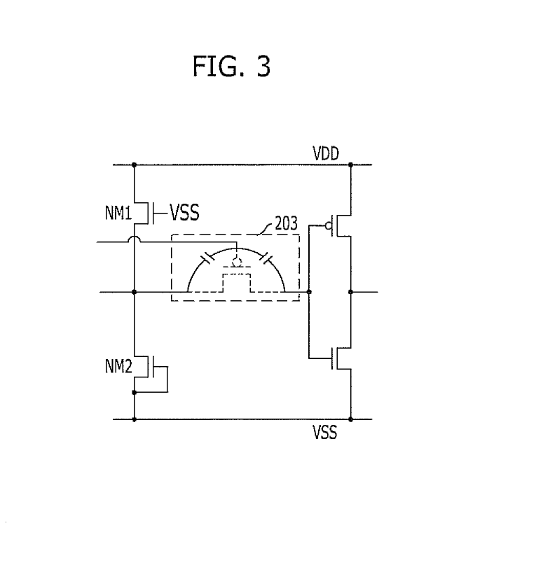

FIG. 3 illustrates an operation of the input buffer protection unit 203 when static electricity is generated in the semiconductor integrated circuit shown in FIG. 2.

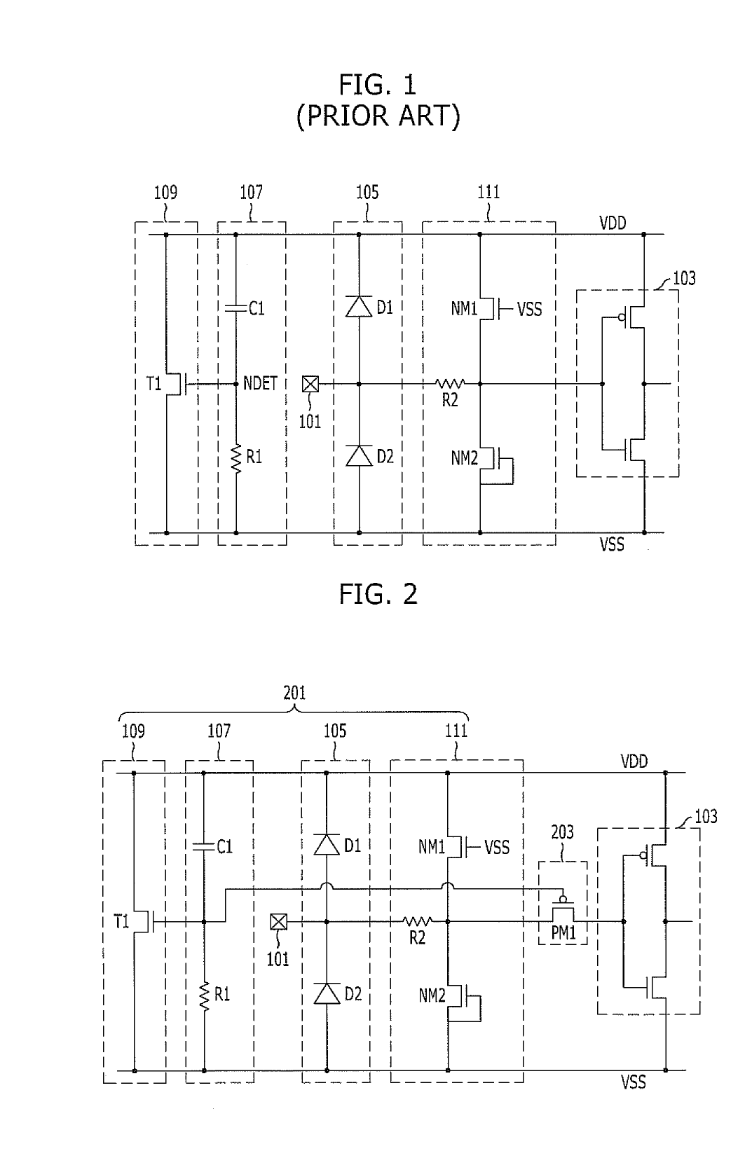

As shown in FIG. 1, when static electricity is generated in the semiconductor integrated circuit, most of the static electricity is discharged through the first discharger 109 and some remaining static electricity enters the input buffer unit 103 through the second discharger 111. As illustrated in FIG. 3, the input buffer protection unit 203 is realized to have the same effect as a capacitor is formed between the second discharger 111 and the input buffer unit 103 when the static electricity is generated. With the input buffer protection unit 203, the electrostatic current flowing to the input buffer unit 103 is blocked once again to thereby disperse the electrostatic voltage.

Therefore, when the static electricity is generated, a low level of electrostatic voltage is applied to an input end of the input buffer unit 103, compared with the conventional semiconductor integrated circuit. Although the thickness of a gate oxide layer is becoming thinner and thinner and the breakdown voltage at which the gate is destroyed becomes low, the gate may be safely protected from the static electricity.

According to an exemplary embodiment of the present invention, a considerable amount of static electricity may be prevented from entering the internal circuits of a semiconductor device by electrically disconnecting an interface pad unit and an input buffer unit from each other when static electricity is caused.

Therefore, although the thickness of a gate oxide layer of an internal MOS device is decreased due to a trend toward the high integration of semiconductor integrated circuits, the gate oxide layer of the internal MOS device may be protected safely from the static electricity.

While the present invention has been described with respect to the specific embodiments, it will be apparent to those skilled in the art that various changes and modifications may be made without departing from the spirit and scope of the invention as defined in the following claims.

What is claimed is:

1. A semiconductor integrated circuit, comprising:
an interface pad unit;
an input buffer unit configured to receive an external signal through the input buffer unit;
an electrostatic discharge unit configured to discharge a static electricity from the interface pad unit; and
an input buffer protection unit configured to electrically disconnect the interface pad unit and the input buffer unit from each other when the static electricity is generated.

2. The semiconductor integrated circuit of claim 1, wherein the electrostatic discharge unit comprises:
a diode configured to discharge charges from the interface pad unit to a power supply voltage end or to a ground voltage end when the static electricity is generated;
an electrostatic sensor configured to activate a discharge signal when the static electricity is generated;
a first discharger configured to form a current path between the power supply voltage end and the ground voltage end when the static electricity is generated; and
a second discharger configured to form a current path between the interface pad unit and the power supply voltage end or between the interface pad unit and the ground voltage end when the static electricity is generated.

3. The semiconductor integrated circuit of claim 2, wherein the input buffer protection unit comprises:
a MOS transistor having a drain-source path between the interface pad unit and the input buffer unit and configured to receive the discharge signal through a gate.

4. The semiconductor integrated circuit of claim 3, wherein the MOS transistor is turned off when the discharge signal is activated and functions as a capacitor between the interface pad unit and the input buffer unit.

5. The semiconductor integrated circuit of claim 2, wherein the electrostatic sensor includes a capacitor coupled with the power supply voltage end and a resistor coupled with the ground voltage end, where the capacitor and the resistor are serially coupled.

6. The semiconductor integrated circuit of claim 5, wherein when the static electricity is generated, a voltage of a node between the capacitor and the resistor is raised over a set voltage level to activate the discharge signal.

7. The semiconductor integrated circuit of claim 2, wherein the second discharger comprises:
a resistor coupled between the interface pad unit and the input buffer protection unit;
a first MOS transistor having a drain-source path between a node disposed between the resistor and the input buffer protection unit and the power supply voltage end; and
a second MOS transistor having a drain-source path between the node disposed between the resistor and the input buffer protection unit and the ground voltage end.

8. The semiconductor integrated circuit of claim 7, wherein the first MOS transistor and the second MOS transistor receive a ground voltage through a gate.

9. The semiconductor integrated circuit of claim 1, wherein the interface pad unit is a pad through which a data is inputted or outputted.

10. A semiconductor integrated circuit, comprising:
an interface pad unit;
an input buffer unit configured to receive an external signal through the input buffer unit;
an electrostatic discharge unit configured to sense a static electricity applied from the interface pad unit, discharge the static electricity, and activate a discharge signal; and
an input buffer protection unit configured to electrically disconnect the interface pad unit and the input buffer unit from each other in response to the discharge signal.

11. The semiconductor integrated circuit of claim 10, wherein the input buffer protection unit comprises:
a MOS transistor coupled between the interface pad unit and the input buffer unit and activated in response to the discharge signal.
